(19) United States
(12) Patent Application Publication
(10) Pub. No.: US 2015/0370345 A1
(43) Pub. Date: Dec. 24, 2015

(54) IDENTIFYING ONE OR MORE WORDS FOR ALTERATION OF USER INPUT OF ONE OR MORE CHARACTERS

(71) Applicant: Lenovo (Singapore) Pte. Ltd., New Tech Park (SG)

(72) Inventors: Russell Speight VanBlon, Raleigh, NC (US); Neal Robert Caliendo, JR., Raleigh, NC (US); Arnold S. Weksler, Raleigh, NC (US)

(21) Appl. No.: 14/310,700

(22) Filed: Jun. 20, 2014

(51) Int. Cl. G06F 3/023; G06F 3/0488; G06F 3/0481; G06F 17/24; G06F 3/0484

(52) U.S. Cl. CPC G06F 3/0237; G06F 17/24; G06F 3/04842; G06F 3/04812; G06F 3/0488

(57) ABSTRACT

In one aspect, a device includes a display, a processor, and a memory accessible to the processor. The memory bears instructions executable by the processor to receive first input pertaining to at least two characters comprising a first character and a second character, present at least the first and second characters on the display, receive second input corresponding to the first character but not corresponding to the second character, present on the display a recommendation of at least one alternate character to the first character in response to receipt of the second input, and present the at least one alternate character on the display in place of the first character in response to third input corresponding to the at least one alternate character.

### I. FIELD

The present application relates generally to identifying one or more words for alteration of user input of one or more characters.

### II. BACKGROUND

When providing user input of one or more characters to a device, e.g. a user may misspell a word and/or there may be one or more alternate words for which the user intended that the input correspond. However, currently devices merely provide static alternatives to the user input in that they do not change based on which portion of the user input the user considers to be incorrect.

### SUMMARY

Accordingly, in one aspect a device includes a display, a processor, and a memory accessible to the processor. The memory bears instructions executable by the processor to receive first input pertaining to at least two characters comprising a first character and a second character, present at least the first and second characters on the display, receive second input corresponding to the first character but not corresponding to the second character, present on the display a recommendation of at least one alternate character to the first character in response to receipt of the second input, and present the at least one alternate character on the display in place of the first character in response to third input corresponding to the at least one alternate character.

In another aspect, a method includes presenting at least one representation of at least one character on a display including a first representation of a first character, and receiving first input corresponding to a location on the display adjacent the first representation of the first character, where the location is one of at least substantially to the left of the first representation and at least substantially to the right of the first representation. The method also includes, based on the location, attempting to identify at least one word comprising the first character.

In still another aspect, a computer readable storage medium that is not a carrier wave bears instructions executable by a processor to present, on a display of a device, respective representations of characters from a sequence of characters, where the sequence includes at least a first character at a first position in the sequence and a second character at a second position in the sequence, and where the respective representations are sequentially presented according to the sequence. The instructions are also executable to, in response to receipt of first input corresponding to the representation of the first character but not corresponding to the representation of the second character, at least attempt to identify at least one word comprising a third character that if substituted for the first character at the first position in the sequence would establish the word based on the sequence and substitution of the first character at the first position with the third character, where the third character is different from the first character.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles;

FIGS. 4-6 and 8 are example user interfaces (UIs) in accordance with present principles; and

FIG. 7 is an example data table in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

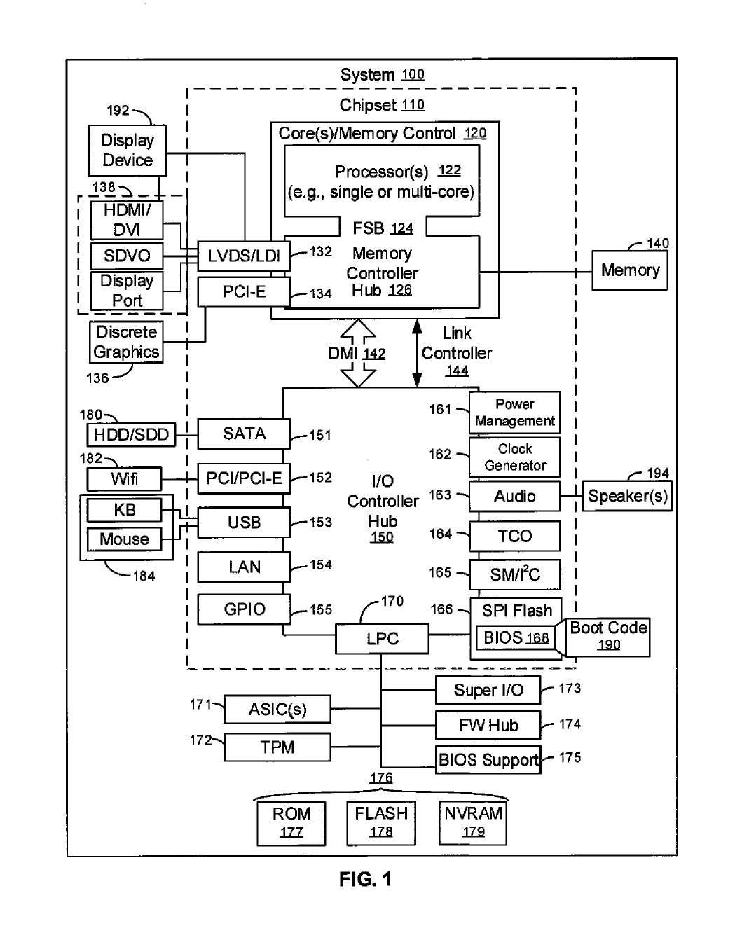

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an 110 controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope for e.g. sensing and/or measuring the orientation of the system 100, an accelerometer for e.g. sensing acceleration and/or movement of the system 100, an audio receiver/microphone in communication with the processor 122 and providing input thereto based on e.g. a user providing audible input to the microphone. Still further, and also not shown for clarity, the system 100 may include a GPS transceiver that is configured to e.g. receive geographic position information from at least one satellite and provide the information to the processor 122. However, it is to be understood that another suitable position receiver other than a GPS receiver may be used in accordance with present principles to e.g. determine the location of the system 100. Furthermore, at least one camera may be included on the system 100, which may be in communication with and provide input to the processor 122. The camera(s) may be, e.g., a thermal imaging camera, a digital camera such as a webcam, and/or a camera integrated into the system 100 and controllable by the processor 122 to gather pictures/images and/or video.

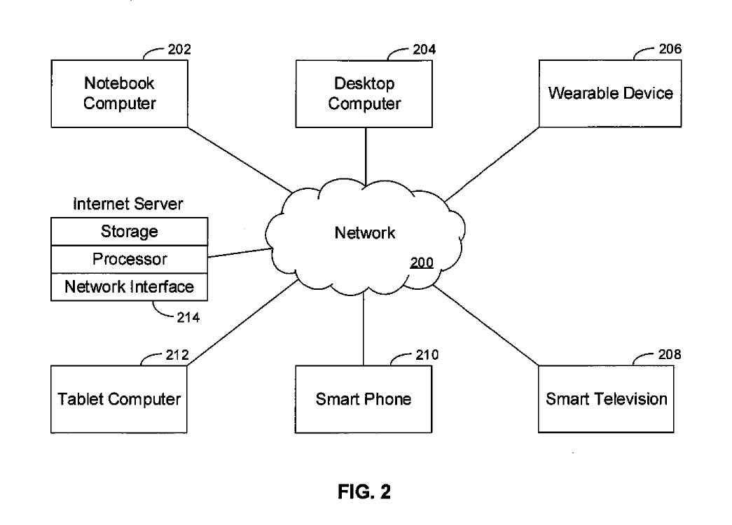

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

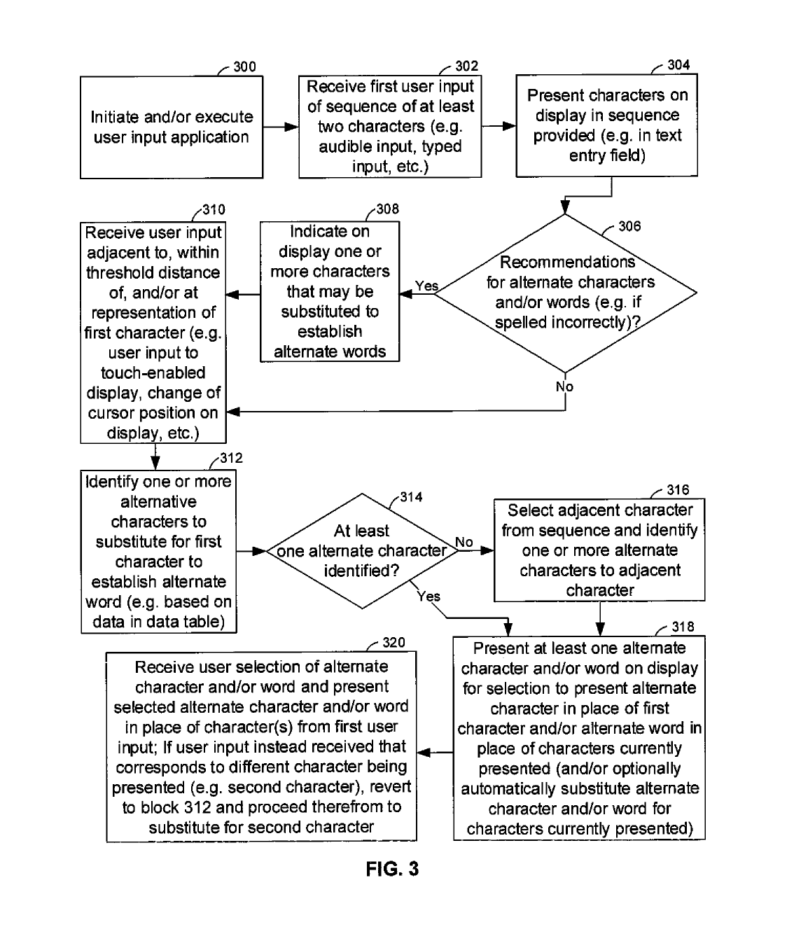

Referring to FIG. 3, it shows example logic that may be undertaken by a device (referred to below as the “present device”) such as the system 100 in accordance with present principles. Beginning at block 300, the logic initiates and/or executes a user input application in accordance with present principles, such as e.g. a text messaging application, an email application, a social networking application, a calendar and/or appointment application, a personal assistant application, a search application, a word processing application, an Internet browser, etc. In any case, after block 300 the logic proceeds to block 302, where the logic receives first user input of a sequence of at least two characters including first and second characters, such as e.g. numerical characters (e.g. Arabic numerals), alphabetical characters (e.g. English alphabetical characters from A to Z), punctuation characters, symbols, etc. The input received at block 302 may be audible input from a user e.g. as detected by a microphone of the present device, input based on manipulation of a keyboard at least in communication with the present device (e.g. a physical keyboard, and/or a keyboard presented on a touch-enabled display of the present device), etc.

From block 302 the logic proceeds to block 304, where the logic presents representations of the characters on the present device's display in the sequence they were received at the present device and/or provided by the user. The sequence may be relative to e.g. the reading style of the language to which the input pertains, such as e.g. the input being in a left to right sequence for English characters. In any case, it is to be understood that the representations may be presented e.g. in a text entry field selected by a user and/or at which the input is otherwise to be represented.

After block 304 the logic may in some embodiments move to decision diamond 306, though it is to be understood that in other embodiments the logic may proceed to block 310 instead, which will be described shortly. Regardless, at decision diamond 306 the logic may determine whether any recommendations can be made and/or indicated for alternate characters to at least one of the characters provided in the first input, and/or whether any recommendations can be made and/or indicated for alternate words to the first input, e.g. based on the logic accessing a data table of words such as the table 700 to be described further below. The decision at diamond 306 may be made e.g. responsive to a determination that the first user input does not establish a correctly spelled word, and hence the logic may provide one or more recommendations of words that contain many of the same characters but with one of the characters from the first user input being substituted with a character establishing a correctly spelled word with the other characters from the first user input.

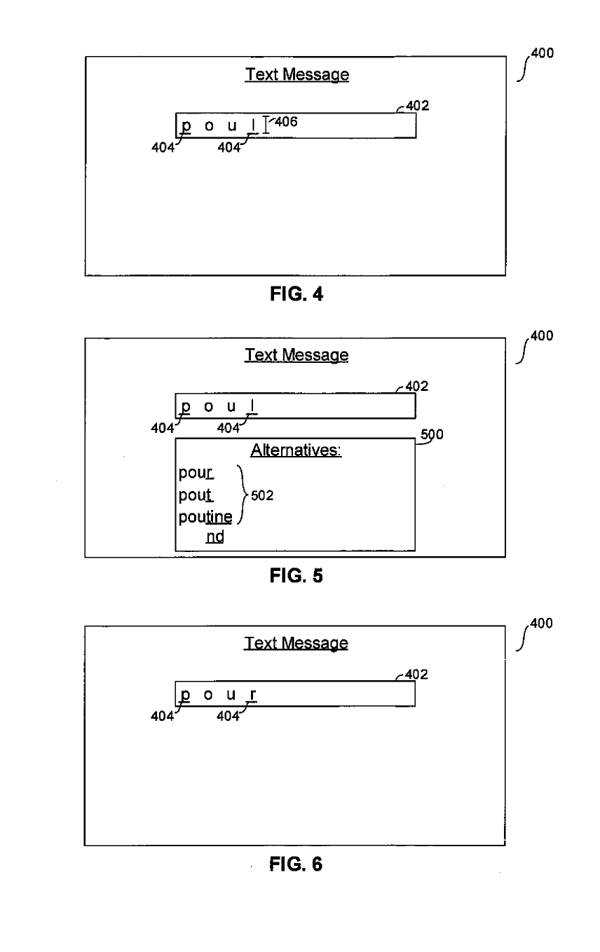

A negative determination at diamond 306 may cause the logic to proceed directly to block 310, but an affirmative determination at diamond 306 may instead cause the logic to first move to block 308. At block 308, the logic may thus indicate and/or highlight on the display of the present device the one or more characters for which substitute characters and/or words have been identified e.g. based on the determination at diamond 306 and/or the data table accessed thereat. An example of such an indication will be discussed further below in reference to FIG. 4.

From block 308 the logic then proceeds to block 310, where the logic receives second user input corresponding to a first character from the first user input represented on the display, such as e.g. a character indicated and/or highlighted at block 308. The second user input may be identified and/or determined to correspond to the first character e.g. based on the input being provided to a display location at least adjacent to where the representation of the first character is presented such as touch-based selection of that display location at the display and/or positioning of a cursor (e.g. a caret) at that display location, within a threshold distance (e.g. predefined and/or user-defined) of the representation of the first character, and/or at the display location at which the representation of the first character is presented. But regardless, it is to be understood that in example embodiments the second input corresponds to the first character but does not correspond to and/or selects the second character (e.g. and/or any other character that may be represented on the display of the present device). E.g., the second input may correspond to and/or be for selection of the first character but not the entire first user input and/or an entire word established based on the first user input so that variations of the first user input may be determined and/or identified based on variance of and/or substitution of the first character but so that other variations of the first user input based on a variance of and/or substitution of another of the characters are not determined and/or identified.

From block 310 the logic proceeds to block 312, where the logic (e.g. if it has not already done so (e.g. such as based on the steps undertaken at diamond 306 and block 308)) identifies one or more alternate characters (and/or one or more words) which may be substituted for the first character to establish an e.g. alternate word to the first user input. The logic may identify one or more alternate characters to at least one of the characters provided in the first input e.g. based on the logic accessing a data table of words such as the table 700 to be described further below.

From block 312 the logic then proceeds to decision diamond 314 where the logic determines whether at least one alternate character (and/or alternate word) has been identified. An affirmative determination at diamond 314 causes the logic to proceed directly to block 318, which will be described shortly. However, a negative determination at diamond 314 instead causes the logic to move to block 316, where the logic may select a character adjacent in the sequence to the first character (e.g. before or after the first character in the sequence) and attempts to identify one or more alternate characters to the adjacent character rather than first character. Thus, in this example should e.g. a user provide input corresponding to the first character as represented on the display but no alternate characters are available for the first character and/or the user intended to actually direct input to an adjacent character for which an alternate character is available, the logic may at block 316 identify an alternate character to the adjacent character.

From block 316 the logic proceeds to block 318, where the logic presents on the display a representation of the at least one alternate character that has been identified (and/or alternate word that has been identified) for selection by a user to present the (e.g. same) representation of the alternate character (and/or alternate word) at the location of the representation corresponding to the first character in place of the first character (and/or if an alternate word, in place of the representation of the first input). Furthermore, note that in some embodiments at block 318 the logic may automatically without further user input replace and/or substitute the first character and/or (e.g. entire) first user input respectively with the alternate character and/or alternate word that was identified.

After block 318 the logic moves to block 320, where the logic receives a selection from a user of one of the alternate characters and/or words represented on the display (e.g. in embodiments where at block 318 the first character and/or currently presented characters were not automatically replaced with the alternate character and/or word that was identified), and accordingly presents the alternate character and/or word in place of the representation of the first character and/or first user input. Also at block 320, if instead of user input being received thereat for selection of one of the alternate characters and/or words, user input is received corresponding to a second character represented on the display different from the first character (e.g. the user wishes to see other recommendations for other characters, and/or the user initially provided erroneous input corresponding to the first character when the intent was to provide input corresponding to the second character, etc.), the logic may in response to such input being received at block 320 revert back to block 312 and proceed therefrom to identify one or more alternate characters to the second character rather than the first character.

Now in reference to FIG. 4, it shows an example user interface (UI) 400 presented on a display of a device such as the system 100. In the present instance, the UI 400 is for a text messaging application. As shown, the UI 400 includes a text entry field 402 at which input from a user may be represented. As may be appreciated from FIG. 4, in the present instance, the user has provided input spelling “pout.” Note that at least one indication 404 is shown of at least one character of the input that if substituted with a different character would establish a correctly spelled word. In this case, the indications 404 are juxtaposed under the respective characters to which they pertain (“p” and “l”). Also note that a cursor caret 406 is shown adjacent to the character “l,” which may have been manipulated to be juxtaposed adjacent to the character “l” by a user to select the character “l” as the one for which the user wishes to have alternate characters presented. Also note that in addition to or in lieu of manipulating the caret 406 as set forth above, the user may touch the portion of the touch-enabled display presenting the character “l” on the UI 400, or at least touch an area proximate to (e.g. within a threshold distance of) the character “l.”

In any case, responsive to user input corresponding to the character “l” shown on the UI 400, one or more recommendations of alternate words may automatically without further user input be presented on the UI 400, as shown in FIG. 5. Thus, as shown in FIG. 5, the recommendations of alternate words may be presented in e.g. a box 500, where each of the alternate words 502 presented therein is selectable to substitute the representation of “poul” with the selected word. Note that owing to the character “l” being selected in this example, words 502 have been identified by the device and presented in the box 500 that still contain the other characters provided in the user input in the sequence they were provided and represented on the display (“pou”), but that e.g. even though the device has determined alternatives to the character “p” as indicated by one of the indications 404, (e.g. only) words 502 with substitutes for the character “l” have been provided rather than for the character “p” and hence each substitute word still contains the characters “pou” in the sequence “pou.” Also note that each of the words 502 contains an indication 504 of the character(s) in the respective word 502 that will replace the character “l” at same position as the character “l” should the respective word 502 be selected (e.g., in this case, the indication 504 is at the fourth character in sequence from left to right since the character “l” in sequence “poul” is the fourth character, left to right).

Still in reference to FIG. 5, also note that characters “nd” have been presented in sequence in the box 500, and that they are (e.g. collectively) selectable to substitute the representation of the character “l” with the characters “nd” to thus establish the word “pound” in the field 402. Accordingly, it is to be understood that any combination of single or plural characters as well as correctly spelled words may be included as recommendations presented in the box 502.

Even further, note that the proper noun “Poutine” has also been presented for selection by the user. Thus, it is to be understood that in some embodiments the logic may determine and recommend words at least including the characters provided by the user other than the selected “l” character in the same sequence provided by the user but also including still additional characters in addition to or beyond the number of characters provided in sequence by the user.

Before moving on to FIG. 6, it is to be understood that from the UI 400 (even as presented in FIG. 5 with the box 500), a user may direct input to another character in the field 402 such as e.g. “p,” which may cause the device to (e.g. dynamically) update the box 500 with alternatives to the character “p” rather than the character “l,” such as e.g. providing recommendations of the words “soul” and “foul.” Thus, e.g. in at least this respect different portions of the input represented in the field 402 may be touched to cycle through different lists of alternate possibilities.

Now in reference to FIG. 6, the UI 400 is again shown but after a user has selected the word “pour” from box 502 to replace “poul” in the field 402, and hence a representation of the word “pour” is shown in FIG. 6 in the field 402. Also note that even though pour is a correctly spelled word, indications 404 are still shown to indicate that the respective characters with the indications 404 (“p” and “r”) may be replaced with other characters in accordance with present principles.

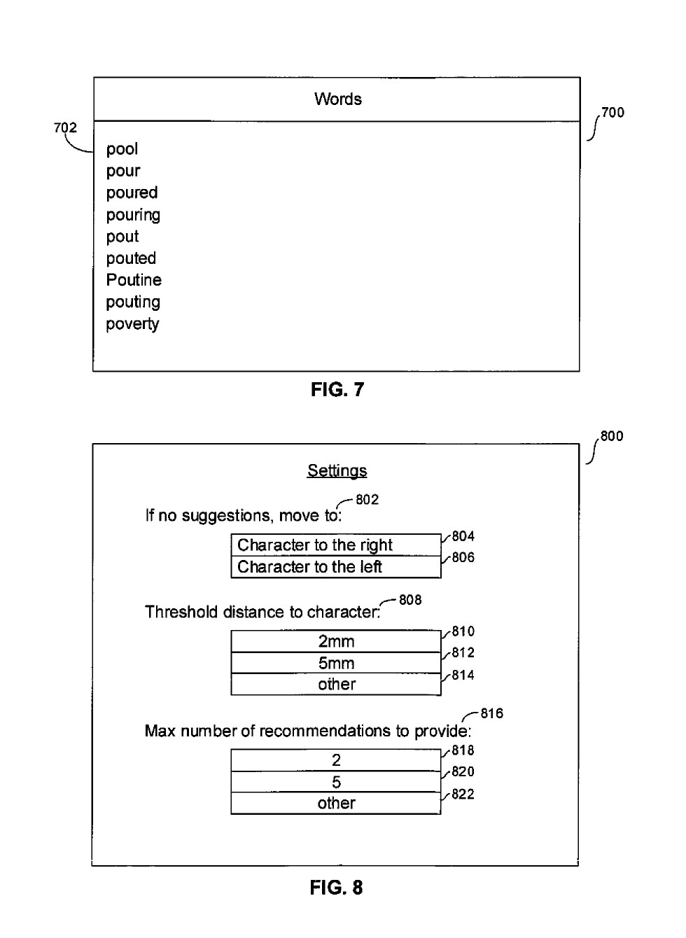

Continuing the detailed description in reference to FIG. 7, it shows an example data table 700 of words that may be accessed by a device in accordance with present principles to e.g. determine if input from a user constitutes a correctly spelled word and/or determine whether alternatives to a character that has been selected by a user in accordance with present principles can be identified and recommended. The table 700 thus includes at least one column 702 of words that in the example shown are in alphabetical order. Taking the example described above in reference to FIGS. 4-6, responsive to user input selecting the character “l” as the character for which recommendations should be provided, the device may access the data table 700 and proceed alphabetically until entries beginning with the sequence of characters “pou” are located to then determine entries in the table 700 including and/or beginning with the characters “pou” but then including a different character than “1.” Once located, the one or more located words from the table 700 may be represented on a UI such as the UI 400 described above (e.g. in the box 500) as recommendations to the user in accordance with present principles.

Now in reference to FIG. 8, an example UI 800 is shown that may be presented on a display of a device such as the system 100 for configuring settings of a device undertaking present principles. The UI 800 includes a first setting 802 for a user to select which adjacent character in a character sequence the device is to select to attempt to identify one or more alternate characters to the adjacent character rather than a character for which alternates could not be identified (e.g. such as at block 316 of the logic described above). Thus, a first selector element 804 is presented that is selectable to automatically without further user input configure the device to select a character to the right of another character for which alternates could not be identified, while a second selector element 806 is presented that is selectable to automatically without further user input configure the device to select a character to the left of another character for which alternates could not be identified. However, note that should there not be adjacent characters in the sequence both to the right and left of a character, but only one or the other (right or left), then the only character next to the one for which an alternate could not be identified will be selected by the device regardless of the configuration of setting 802.

The UI 800 also includes a second setting 808 for configuring a threshold distance for user input selecting a character in accordance with present principles (e.g. for use by the device at block 310 of the logic above). Thus, a first selector element 810 is presented that is selectable to automatically without further user input configure the device to establish the threshold distance at two millimeters, a first selector element 812 is presented that is selectable to automatically without further user input configure the device to establish the threshold distance at five millimeters, and a third selector element 814 is presented that is selectable to configure the device to establish a threshold distance of another length specified by a user (e.g. using a pop-up and/or overlay window to which a user may enter a number and unit (e.g. millimeters, centimeters, etc.) for the number).

Still in reference to FIG. 8, the UI 800 also includes a third setting 816 for setting a maximum number of recommendations that the device may present on its display as alternates for substitution in accordance with present principles (e.g. such as in the box 500 described above). Thus, a first selector element 818 is presented that is selectable to automatically without further user input configure the device to establish the number at two recommendations, a second selector element 820 is presented that is selectable to automatically without further user input configure the device to establish the number at five recommendations, and a third selector element 822 is presented that is selectable to configure the device to establish another number of maximum recommendations to present as specified by a user (e.g. using a pop-up and/or overlay window to which a user may enter a number).

Although not shown in FIG. 8, it is to be understood that the UI 800 may include still other settings for configuration by a user. E.g. a setting may be presented for the user to configure the device to automatically replace one character with an alternate character (e.g. such as at block 318 as described above) or to not automatically do so.

Without reference to any particular figure, it is to be understood that in addition to or in lieu of recommending substitution of one character for another as described herein, a device in accordance with present principles may also determine that one or more characters may be added to a sequence of input from a user rather than substituted for a character from the input. Thus, e.g., if a user touches a single character represented on the display, rather than substituting for the character, one or more words comprising the character may be determined. E.g., if the user enters (e.g. only) the character “t”, the user could have accidentally omitted a letter rather than mistyped a letter. If the user were to touch a location on the display before the representation of the letter “t” (e.g. to the left of the letter), the device may determine word suggestions to recommend comprising characters in a word sequence before the letter “t” that establish a word including the letter “t” such as e.g. “it” or “at.” Similarly, by the user touching a location after the letter “t” (to the right of the letter), the device may determine word suggestions to recommend comprising characters in a word sequence after the letter “t” that establish a word including the letter “t” such as e.g. “to” or “the”.

As another example, if the user types the letter “o,” touching before the letter “o” will cause the device to recommend the words e.g. “to”, “so”, and/or “go”, while touching after letter “o” will cause the device to recommend the words “on”, “off”, and/or, “okay”. The foregoing applies even when e.g. plural characters have been indicated by a user (e.g. touching before the plural characters will cause the device to recommend a word comprising other characters in a word sequence for the word before the characters from the user input that in part establish the word). Notwithstanding, in addition to or in lieu of the foregoing recommendations for e.g. the letter “o”, words established by a single letter may also be recommended as substitutions for the letter “o”, such as the words e.g. “a” and “I”.

Moving on, it is to be understood that in addition to the threshold distances described herein, in some embodiments a threshold number of characters may be established for selection of a character a threshold number of characters away from a selected character for which there are no available alternates and/or which has not been indicated as having at least one alternate. E.g., the threshold character distance may be two characters away in either direction in the sequence.

Also without reference to any particular figure, it is to be understood that e.g. if touch input is received to an area of a touch-enabled display between two characters, various determinations may be made for which character to select for presenting alternates in accordance with present principles. E.g., if only one of the two characters has possible alternates, that character may be selected. If both characters have possible alternates, the character to which the input was most closely directed will be selected.

Furthermore, in some embodiments a user may select not only a single character for which alternates may be presented, but may select e.g. a set of characters consecutively in sequence to thus cause the device to suggest alternates to replace the set (or at least one character in the set).

Also in some embodiments, it is to be understood that selection of a character for which alternates are to be presented, and/or manipulation of a cursor for selection of the character, may be provided by a user e.g. using voice input (e.g. a command “show alternatives to the letter ‘p’”) as well as touch input, and furthermore may be selected using e.g. a mouse and/or keyboard.

In addition to the foregoing, it is to be understood that when the present application refers to presenting an alternate character on the display in place of and/or substituted for another (e.g. first) character, such may entail replacing only the first character with the alternate character, and/or replacing the entire representation of user input with the word containing the alternate character (e.g. to thus yield a net result relative to the user that only alternate character has changed).

It may now be appreciated that present principles provide for detecting where a user touches a word presented on a display when making a text correction for the word. E.g. based on where the user touches (and/or clicks) a portion of a word, auto-correct suggestions may be presented and/or updated depending on potential corrections that may be made at the character corresponding to e.g. the current cursor position. If no potential corrections exist where the user selects a portion of the word, nearby letter positions may be used to determine auto-correct suggestions.

E.g., if the user touches the beginning of a word, auto-correct suggestions may prioritize alternate words to be presented based on words with different beginnings from the “active” word provided by the user. If the user touches the end of a word, auto-correct suggestions may prioritize alternate words to be presented based on words with different endings from the “active” word.

Thus, providing examples, input from a user may be “poul.” A touch at the beginning of the word may cause a suggestion of “foul,” whereas a touch at the end of the word may cause a suggestion of “pour.”

If input from a user were “caboe,” a touch at the middle of the word may cause a suggestion of “canoe,” whereas a touch at the end of the word may cause a suggestion of “cable” (e.g. when there are no possible alternates for the character “e” and/or when the character “I” has been selected).

If input from a user were “teal,” a touch at the beginning of the word may cause a suggestion of “seal” and/or “heal,” whereas a touch at the end of the word may cause a suggestion of “tell” or “team.”

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave and/or another signal per se.

While the particular IDENTIFYING ONE OR MORE WORDS FOR ALTERATION OF USER INPUT OF ONE OR MORE CHARACTERS is herein shown and described in detail, it is to be understood that the subject matter which is encompassed by the present application is limited only by the claims.

What is claimed is:

1. A device, comprising:
a display;
a processor;
a memory accessible to the processor and bearing instructions executable by the processor to:
receive first input pertaining to at least two characters comprising a first character and a second character;
present at least the first and second characters on the display;
receive second input corresponding to the first character but not corresponding to the second character;
present on the display a recommendation of at least one alternate character to the first character in response to receipt of the second input; and
in response to third input corresponding to the at least one alternate character, present the at least one alternate character on the display in place of the first character.

2. The device of claim 1, wherein the first input is audible input to the device.

3. The device of claim 1, wherein the first and second characters are presented in a text entry field of a user interface (UI), the UI presented on the display.

4. The device of claim 1, wherein the display is a touch-enabled display, and wherein the second input is received at a location on the touch-enabled display corresponding to the first character.

5. The device of claim 4, wherein the location is a portion of the touch-enabled display at least adjacent the location of the first character.

6. The device of claim 4, wherein the location is a portion of the touch-enabled display presenting the first character.

7. The device of claim 1, wherein the second input is received based on manipulation of a cursor to a location at least adjacent the first character.

8. The device of claim 1, wherein the recommendation comprises plural words, wherein at least a first word of the plural words contains the alternate character at a word position in the first word corresponding to the position of the first character as received in the first input.

9. The device of claim 8, wherein the first word contains the second character.

10. The device of claim 1, wherein the recommendation is presented in response to identification, from a data table comprising plural words, of a word containing the alternate character at a word position corresponding to the position of the first character as received in the first input.

11. A method, comprising:
presenting at least one representation of at least one character on a display including a first representation of a first character;
receiving first input corresponding to a location on the display adjacent the first representation of the first character, the location being one of at least substantially to the left of the first representation and at least substantially to the right of the first representation; and
based on the location, attempting to identify at least one word comprising the first character.

12. The method of claim 11, wherein the location is to the left of the first representation, and wherein the method includes identifying at least one word comprising at least a second character adjacent to the first character in a sequence of characters establishing the word, the second character being to the left of the first character in the sequence of characters establishing the word.

13. The method of claim 11, wherein the location is to the right of the first representation, and wherein the method includes identifying at least one word comprising at least a second character adjacent to the first character in a sequence of characters establishing the word, the second character being to the right of the first character in the sequence of characters establishing the word.

14. The method of claim 11, further comprising identifying the at least one word and presenting on the display adjacent to the first representation a second representation, the second representation being of the word, the second representation being selectable to present a representation of the word at the location of the display at which at least a portion of the first representation is presented.

15. The method of claim 11, wherein the method comprises, when presenting the at least one representation, determining that the at least one character does not establish a correctly spelled word, and indicating on the display a character of that at least one character that if substituted with a different character would establish a correctly spelled word.

16. The method of claim 11, wherein the display is a touch-enabled display, and wherein the first input is determined to correspond to the location based on a determination that the first input has been provided to a portion of the touch-enabled display within a threshold distance of the first representation of the first character.

17. A computer readable storage medium that is not a carrier wave, the computer readable storage medium comprising instructions executable by a processor to:
present, on a display of a device, respective representations of characters from a sequence of characters, the sequence comprising at least a first character at a first position in the sequence and a second character at a second position in the sequence, the respective representations being sequentially presented according to the sequence; and
in response to receipt of first input corresponding to the representation of the first character but not corresponding to the representation of the second character, at least attempt to identify at least one word comprising a third character that if substituted for the first character at the first position in the sequence would establish the word based on the sequence and substitution of the first character at the first position with the third character, the third character being different from the first character.

18. The computer readable storage medium of claim 17, wherein the word is a first word, and wherein the instructions are executable to:
in response to receipt of second input corresponding to the representation of the second character but not corresponding to the representation of the first character, at least attempt to identify at least a second word comprising a fourth character that if substituted for the second character at the second position in the sequence would establish the second word based on the sequence and substitution of the second character at the second position with the fourth character, the fourth character being different from the second character.

19. The computer readable storage medium of claim 18, wherein the instructions are executable to:
in response to receipt of the first input and without additional input from a user, identify the first word and present on the display a representation of the first word; and
in response to receipt of the second input and without additional input from a user, identify the second word and present on the display a representation of the second word.

20. The computer readable storage medium of claim 18, wherein the instructions are executable to:
in response to a failure to identify at least a second word comprising a fourth character that if substituted for the second character at the second position would establish the second word based on the sequence and substitution of the second character at the second position with the fourth character, select a third character adjacent the second character in the sequence and at least attempt to identify at least a third word comprising a fifth character that if substituted for the third character in the sequence would establish the third word based on the sequence and substitution of the third character in the sequence with the fifth character, the fifth character being different from the third character.
